(19) United States
(12) Patent Application Publication
(10) Pub. No.: US 2006/0291950 A1
(43) Pub. Date: Dec. 28, 2006

(54) Stripe & touch paint tool and method of use

(76) Inventor: Richard G. Cooper, Marysville, CA (US)

Correspondence Address: Galasso & Associates, LP, P.O. Box 26503, Austin, TX, 78755-0503, US

(21) Appl. No.: 11/385,510

(22) Filed: Mar. 21, 2006

Related U.S. Application Data
(60) Provisional application No. 60/689,939, filed on Jun. 11, 2005.

(51) Int. Cl. B43M 11/06

(52) U.S. Cl. 401/183

(57) ABSTRACT

A painting device for use in the home or automobile industry that allows for quick and easy repairs and touch-ups. The painting device includes a squeezable cylinder capable of holding a solution. On one end of the squeezable cylinder is a removable lid to protect the flow tip. On the other end of the squeezable cylinder is a removable cap which opens providing the ability to fill the squeezable cylinder with a solution. The solution is then dispensed out the flow tip or paint brush end of the cylinder by squeezing the squeezable cylinder. The squeezable cylinder is designed to hold and dispense a variety of solutions.

### RELATED APPLICATIONS

This application claims priority to U.S. Provisional patent application Ser. No. 60/689,939 filed on Jun. 11, 2005.

### FIELD OF THE DISCLOSURE

A tool capable of providing an easy means for repairing and touching up paint as well as painting stripes.

### BACKGROUND

People are becoming more and more obsessed with the look of their belongings. From vehicles to houses, everything is a status symbol as well as the condition which a person keeps those possessions.

Keeping the walls of a home touched up and free from scratches and knicks is a full time job, especially if children live in the household. Taking the time to dig out the paint and brushes, do the touch ups and then cleaning these tools is something most people dread. Additionally, it there are actual dings in the wall that need patching, then the process becomes more of an ordeal.

The same types of everyday dents and dings happen with our vehicles. While traveling down the road on a daily basis, our cars are hit by rocks and various other things that chip the paint. Additionally, cars are banged up in the parking lots on a daily basis. People do not seem to care that they open their car door into your car. Car doors slammed into one car is probably the biggest cause of paint chips to automobiles.

There are several options on the market that provide a means for correcting small defects for other things like furniture. There are marker pens that come in varying colors that are designed to match different stain types. There are even different types of wood fillers that come in a pen type dispenser for repairing wood. The particular types of fillers also come in varying colors so as to match the varying stain colors.

However, there is not anything available for paint that allows a user the ability to do small touch ups without using a brush. Additionally, the ability to do minor repairs to walls in requires the use of other tools. The same is true for automobile repairs. Often times there are small dents that are too big to repair with just paint. These types of dents require a certain amount of filler before actually repainting. If there was an object on the market that provided the ability to repair these types of dents it would be well received, especially by automobile painters. Also, the ability to do small touch ups with paint would make paint repairs a simpler and easier task to perform.

### SUMMARY OF THE DISCLOSURE

In one embodiment the painting device comprises a squeezable cylinder having a first end and a second end.

In another embodiment the painting device comprises a screw on lid.

In still another embodiment the screw on lid attaches to the first end of the squeezable cylinder.

In yet another embodiment the painting device comprises a removable cap.

In still another embodiment the removable cap allows for filling of the squeezable cylinder on the second end.

In yet another embodiment the cap functions to seal the cylinder on the second end.

In still anther embodiment the painting device comprises a removable squirrel hair paint brush type head.

In another embodiment the removable squirrel hair paint brush type head attaches to the squeezable cylinder.

In yet another embodiment the painting device comprises a set of flow tips.

In still another embodiment the flow tips function to dispense solution.

In another embodiment the flow tips are attachable to the squeezable cylinder.

In yet another embodiment the squeezable cylinder holds paint.

In still another embodiment the squeezable cylinder holds primer.

In another embodiment the squeezable cylinder is reusable.

In yet another embodiment the flow tips comprise a screw connection for attaching to the squeezable cylinder.

In still another embodiment the flow tips are comprised of varying size tips.

In another embodiment the one of the flow tips comprises a double head for painting.

In yet another embodiment the flow tips are comprised of metal.

In still another embodiment the flow tips are include brushes comprised of squirrel hair.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 illustrates a paint cylinder including a lid, a cap and a removable head.

FIG. 2 illustrates a view of varying removable heads.

### DETAILED DESCRIPTION OF THE DRAWING FIGURES

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

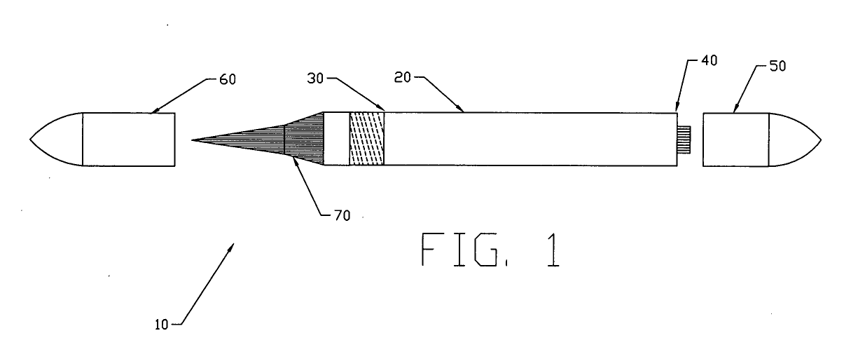

FIG. 1 illustrates a painting device 10 capable of holding paint within a squeezable cylinder 20. The squeezable cylinder 20 has a first end 30, a second end 40, a screw on lid 50, a removable cap 60, a squirrel hair paint brush 70 type head and a set of flow tips 80. Since the squeezable cylinder 20 can be refilled it could be purchased either filled or empty. By removing the cap 60 the squeezable cylinder 20 can be filled with paint, filler compound or primer. However, before the squeezable cylinder 20 is filled with a solution, the appropriate flow tip 80 would need to be selected. Since the squeezable cylinder 20 is designed to include a removable squirrel hair paint brush 70 type head, the appropriate flow tip would need to be selected. The screw on lid 50 functions to protect the squirrel hair paint brush 70 when attached to the squeezable cylinder 20. Once the lid 50 is removed, the squirrel hair paint brush 70 can be used or removed. The squirrel hair paint brush 70 and the flow tips all comprise a screw attachment for attaching to the squeezable cylinder 20. In order to dispense the solution from the squeezable cylinder 20, a user would simple squeeze the squeezable cylinder gently to disperse the solution. Once a task is completed, the flow tips 80, the squeezable cylinder 20 and the squirrel hair paint brush 70 can be cleaned with the appropriate solution. If a user thought they would have a need to reuse the solution in the squeezable cylinder 20 in the near future, they could simply place the lid 50 on the squeezable cylinder 20 for later use, rather than clean the entire painting device 10 between uses.

The painting device 10 is designed to be used for a number of tasks. It could be used repair and touch-up paint in a house. Additionally, the painting device 10 could be used in the automobile repair business. The painting device 10 would allow an automobile paint person the ability to quickly and easily make minor repairs to the paint and even do minor repairs to varying small dents and dings. When used in connection with automobile paint touch-ups and repairs, one could have more than one painting device 10. By using the painting device 10 to repair automobile paint, it would prevent the need to have paint buckets and be concerned with oversized brushes and dripping.

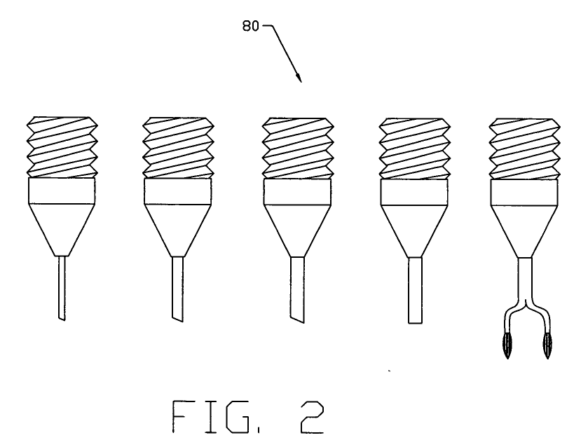

FIG. 2 illustrates a set of flow tips 80 which would function in connection with the squeezable cylinder 20 of the painting device 10. Each of the flow tips 80 include a screw connection for connecting to the squeezable cylinder 20. The flow tips 80 which are shown here are meant to be illustrative and not limit the scope of the type or size of the flow tips 80. The flow tips 80 can also include varying types of paint brushes. For example, one of the flow tips 80 illustrated includes a double head. This double head flow tip 80 allows a user to paint a set of stripes which would look identical. While the most common use of this type of device would be to paint stripes on cars, the use of stripes has become very popular in the painting of walls. The use of some of the other flow tips 80 would work better for patching and/or filling dents.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. An painting device comprising:
a squeezable cylinder for holding a solution having a first end and a second end;
a snap on lid operable to attach to said first end;
a removable cap to allow for filing said squeezable cylinder on said second end; and wherein said cap functions to seal said squeezable cylinder on said second end;
a removable squirrel hair paint brush type head attached to said squeezable cylinder; and
a set of flow tips for dispensing said solution.

2. The painting device of claim 1 wherein said squeezable cylinder holds a filler compound for filling dents.

3. The painting device of claim 1 wherein said squeezable cylinder holds primer.

4. The painting device of claim 1 wherein said squeezable container is reusable.

5. The painting device of claim 1 wherein said flow tips comprise a screw connection for attaching to said squeezable cylinder.

6. The painting device of claim 1 wherein said flow tips comprises varying size tips.

7. The painting device of claim 1 wherein one of said flow tips comprises a double head for painting double stripes.

8. The painting device of claim 1 wherein said flow tips are comprised of metal.

9. The painting device of claim 1 wherein said set of flow tips include brushes comprised of squirrel hair.

10. A painting system comprising:
a squeezable cylinder for holding a solution having a first end and a second end;
a snap on lid operable to attach to said first end;
a removable cap to allow for filing said squeezable cylinder on said second end; and wherein said cap functions to seal said squeezable cylinder on said second end;
a removable squirrel hair paint brush type head attached to said squeezable cylinder; and
a set of flow tips for dispensing said solution; and wherein said flow tips are attachable to said cylinder on said first end.

11. The painting device of claim 10 wherein said squeezable cylinder holds paint.

12. The painting device of claim 10 wherein said squeezable cylinder holds a filler compound for filling dents.

13. The painting device of claim 10 wherein said squeezable cylinder holds primer.

14. The painting device of claim 10 wherein said squeezable container is reusable.

15. The painting device of claim 10 wherein said flow tips comprises varying size tips.

16. The painting device of claim 10 wherein one of said flow tips comprises a double head for painting double stripes.

17. The painting device of claim 10 wherein said flow tips are comprised of metal.

18. A method of painting comprising a squeezable cylinder, a cap, a lid, a paint brush type head and a set of flow tips; the steps comprising:
removing said cap;
filling said squeezable cylinder with a paint or primer solution;
replacing said cap;
removing said lid;
deciding on a flow tip;
removing said paint brush type head;
attaching the selected flow tip;
painting a surface; and
cleaning said flow tip, paint brush type head and squeezable cylinder.
